(19) United States
(12) Patent Application Publication
(10) Pub. No.: US 2015/0135969 A1
(43) Pub. Date: May 21, 2015

(54) Method for Obtaining a Cooking Container Comprising an Electrochemically Colored Anodized Outer Face

(71) Applicant: SEB S.A., Ecully (FR)

(72) Inventors: Martin Rubio, Rumilly (FR); Stephane Tuffe, Cognin (FR)

(21) Appl. No.: 14/400,749

(22) PCT Filed: May 6, 2013
(86) PCT No.: PCT/FR2013/051011

§ 371 Date: Nov. 12, 2014

(30) Foreign Application Priority Data
May 16, 2012 (FR) 1254547

(51) Int. Cl. H05B 6/12; C25D 7/04; C25D 11/02; C25D 11/22

(52) U.S. Cl. CPC H05B 6/1209; C25D 11/22; C25D 7/04; C25D 11/024; H05B 6/1227
USPC 99/358; 205/151; 205/50

(57) ABSTRACT

Provided is a method for obtaining a cooking container comprising the following steps: producing a vessel having an aluminium outer face and an inner face, performing anodisation on at least the outer face of the vessel to obtain an anodic coating having pores. At least one colouring step is carried out on the anodised outer face after anodisation, the colouring step or steps implements at least one metal salt deposited at the bottom of the pores of the anodic coating by electrochemical technique. Also provided is a culinary article or an electric cooking appliance comprising a cooking container obtained according to the abovementioned method.

The present invention relates to the technical field of cooking utensils and appliances comprising a cooking container.

The present invention relates more particularly, but not exclusively, to culinary articles such as casseroles, skillets, or woks and also to electric cooking appliances comprising a vessel designed to contain foods.

Document GB 1 099 486 discloses the production of aluminum cooking containers comprising a hard-anodized surface layer. If desired, this surface layer can be pigmented. The surface thus obtained is easier to clean than a non-anodized surface. Nevertheless the surface thus obtained is not as easy to clean as a surface coated with a non-stick layer.

Document EP 0 424 072 and document EP 0 902 1 05 propose the production of cooking vessels comprising a non-stick coating such as PTFE on a hard-anodized aluminum substrate. The hard anodization is thus carried out prior to the PTFE coating. This arrangement makes it possible to improve the resistance of the PTFE coating to wear and to scratches. Typically, the PTFE coating is chiefly used to coat the inner face of the cooking containers because of the limited mechanical resistance of this type of coating.

Document EP 1 894 502 discloses the provision of a sol-gel coating on at least one face of a culinary article comprising an aluminum or aluminum alloy substrate, wherein this substrate can be made of anodized aluminum. This document envisions an anodization layer thickness of between 5 and 10 μm. If desired, the other face can be coated with PTFE. The sol-gel coating makes it possible to improve the dishwasher durability of the cooking container as well as the flame resistance of the cooking container.

Document FR 2 967 563 discloses the production of a cooking container comprising a hard-anodized and colored outer face, for which container a sol-gel coating is provided on the hard-anodized outer face. Such an embodiment makes it possible to obtain cooking containers for which the colorings of the outer face have a durable nature, able to withstand the detergents used in dishwashers, and flame resistant. A disadvantage of the proposed embodiment resides in the complexity of the production method employed, which requires many steps.

Application FR 11 60130 discloses the production of a cooking container comprising a hard-anodized outer face, which is colored in a coloring step employing at least one water-soluble inorganic pigment. Such an embodiment makes it possible to obtain cooking containers for which the colorings of the outer face have a durable nature, are able to withstand the detergents used in dishwashers, and are flame resistant without needing a sol-gel coating on the hard-anodized outer face. A disadvantage of the proposed embodiment resides in the limited spectrum of possible colorings, which range from pale yellow to brown and are obtained by manipulating the concentration of the coloring baths, the temperature, and the dipping time.

French patent application no. 12 52086 discloses the production of a cooking container comprising a hard-anodized outer face, which is colored in a coloring step employing at least one water-soluble anthraquinonic organic dye. Such an embodiment makes it possible to obtain cooking containers for which the colorings of the outer face have a durable nature and are flame resistant. The colorings thus obtained are in the blue range. However, the resistance of these colorings to the detergents used in dishwashers is limited.

An object of the present invention is to propose a wide choice of colorings for the anodized outer surface of a cooking container that have a durable nature without requiring any protective coating.

Another object of the present invention is to propose a wide choice of colorings for the anodized outer surface of a cooking container that are able to withstand flames or any other source of heat used for cooking without requiring any protective coating.

Another object of the present invention is to propose a wide choice of colorings for the anodized outer surface of a cooking container that are able to withstand the detergents used in dishwashers without necessarily requiring any protective coating.

An additional object of the present invention is to propose a wide choice of colorings for the anodized outer surface of a cooking container that are compatible with a PTFE coating of the inner surface of said cooking container without necessarily requiring a protective coating.

These objects are achieved with a method for obtaining a cooking container comprising the following steps:

producing a vessel having an aluminum outer face and an inner face,

performing anodization on at least the outer face of the vessel to obtain an anodic coating with pores,

wherein at least one coloring step is carried out on the anodized outer face after anodization and wherein the coloring step or at least one of the coloring steps implements at least one metal salt deposited at the bottom of the pores of the anodic coating by electrochemical means.

In other words, the coloring step or at least one of the coloring steps employs an electric current to effect the deposition of the one or more metal salts in the pores of the anodic coating.

These arrangements make it possible to obtain a broader range of colorings of the anodized outer surface of a cooking container, without necessarily requiring a protective coating, which are able to withstand flames or any other source of heat used for cooking, which are able to withstand the detergents used in dishwashers, and which allow a PTFE coating to be provided on the inner surface of said cooking container.

If desired, at least one sealing treatment can be performed on the colored anodized outer face after the electrochemical coloring and/or an additional protective coating can be applied on at least the colored anodized outer face.

According to a first embodiment making it possible to obtain certain colors, the coloring step or at least one of the coloring steps employs an alternating current for depositing the one or more metal salts at the bottom of the pores of the anodic coating. Such a coloring is an electrolytic coloring, making it possible to obtain colors in the champagne, bronze, brown or black range.

According to a second embodiment making it possible to obtain a broader spectrum of colors, a preliminary electrochemical treatment step is performed on the anodized outer face after the anodization, said preliminary treatment step using direct current and alternating current alternately in order to modify the shape of the pores of the anodic coating, the preliminary electrochemical treatment step being followed by the coloring step or at least one of the coloring steps using alternating current to deposit the one or more metal salts at the bottom of the pores of the anodic coating.

Such a coloring is an interferential electrocoloring that allows more colors to be obtained because the pores of modified shape absorb certain wavelengths and reflect other wavelengths, which are perceived by the eye.

The metal salt or at least one of the metal salts is advantageously chosen from the salts of tin, copper, nickel, cobalt, selenium, manganese, zinc, silver, gold, chromium, barium or molybdenum.

According to a preferred embodiment, said method comprises a step of providing a PTFE coating on the inner face of the vessel. If desired, the step of providing a PTFE coating can comprise a surface preparation as well as the depositing of one or several intermediate layers. The PTFE coating can be applied in particular by lamination.

According to an embodiment then, the method comprises a step of providing a PTFE coating on the inner face of the vessel, and the step anodizing the outer face of the vessel comes after the step of providing a PTFE coating on the inner face of the vessel.

Anodization performed after the PTFE coating has the advantage of only anodizing the outer face of the vessel, thus making it possible to shorten the treatment time and reduce the consumption of power and acid compared to anodization of both the outer face and the inner face of the vessel. Furthermore, the PTFE effectively withstands the sulfuric acid bath typically used for anodization.

If desired, the method comprises a step of performing preliminary hard anodization of the outer face and of the inner face of the vessel before the step of providing a PTFE coating on the inner face of the vessel, wherein the step of anodizing the outer face of the vessel comes after a step of stripping the outer face of the vessel subsequent to the step of providing a PTFE coating on the inner face of the vessel. This preliminary hard anodization treatment involves the inner face and the outer face of the vessel and makes it possible to obtain a hard base before providing the PTFE coating.

According to another embodiment, the anodization step and the coloring step are carried out on the inner face and the outer face of the vessel. This anodization treatment involves the inner face and the outer face of the vessel. If desired, the anodization treatment can be a hard anodization treatment for obtaining a hard base.

The method advantageously comprises a step of providing a PTFE coating on the inner face of the vessel after the coloring step. Carrying out the step of providing a PTFE coating after the coloring step is conceivable because the pigments envisioned are resistant to the temperatures used during the baking of the PTFE coating.

According to an advantageous feature of the invention, anodization is performed at a temperature greater than or equal to 0° C. At lower anodization temperatures, the pores formed during anodization are in fact very dense and very small and the coloring of the hard-anodized surface is not achieved.

According to another advantageous feature of the invention, anodization is performed at a temperature lower than or equal to 17° C. At higher anodization temperatures, the pores formed during anodization are too large and the anodization is not sufficiently hard, even though the coloring is effectively achieved.

According to a preferred feature of the invention, anodization is performed at a temperature of between 5° C. and 12° C. At this temperature range, the pores formed during anodization are sufficiently small so that the anodized surface is sufficiently hard and sufficiently large so that the one or more metal salts used for the coloring are effectively deposited in the pores of the anodic coating.

These objects are also achieved with a cooking container comprising a vessel having an aluminum outer face and an inner face, the outer face being anodized and colored, said cooking container being obtained according to a method compliant with at least one of the aforementioned features.

According to an advantageous embodiment, the vessel is obtained by stamping a substrate having at least one aluminum face, said face then forming the outer face of the vessel.

According to an embodiment then, the substrate has two aluminum faces. In particular the substrate can be made of solid aluminum or of a colaminate having two aluminum faces and a steel core. If desired, the steel can be chosen from the stainless steels.

According to another embodiment then, the substrate is formed by a colaminate having an aluminum face and a stainless steel face, this stainless steel face being advantageously designed to be coated with PTFE.

According to another advantageous embodiment, the vessel is made of die-cast aluminum.

According to an advantageous embodiment, the outer face of the vessel has a brushed or micro-blasted surface. The anodization treatment is a surface treatment in which the material of the surface is modified and not a surface coating in which one or several layers are added to an existing surface. The anodization treatment is not limited to the smooth or polished surface states; in particular anodization is conceivable on a brushed or micro-blasted surface.

For obtaining an induction-compatible cooking container, the vessel advantageously comprises at least one insert made of ferromagnetic material.

These objects are also achieved with a culinary article comprising a cooking container and a handle attached to said cooking container by at least one rivet or by welding, said cooking container complying with at least one of the aforementioned features.

These objects are also achieved with an electric cooking appliance comprising a cooking container associated with heating means, said cooking container complying with at least one of the aforementioned features.

The invention will be more clearly understood by studying exemplary embodiments that are in no way limiting and illustrated in the appended figures, wherein:

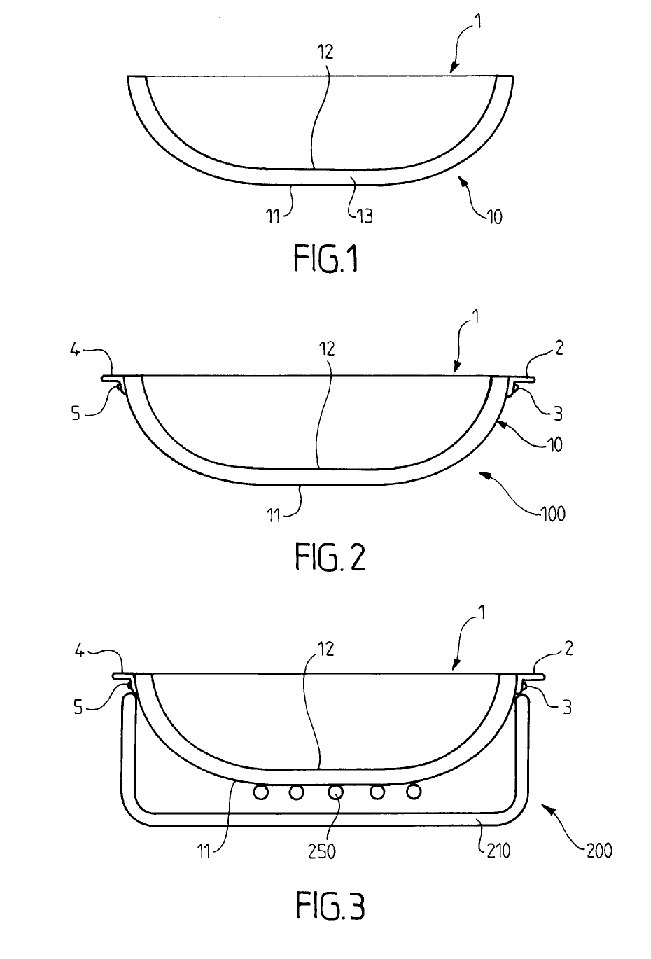

FIG. 1 illustrates a cooking container 1 of the invention,

FIG. 2 illustrates a culinary article 100 comprising a cooking container 1 of the invention,

FIG. 3 illustrates schematically an electric cooking appliance 200 comprising a cooking container 1 of the invention.

The cooking container 1 illustrated in FIGS. 1 and 2 comprises a vessel 10 having an aluminum outer face 11 as well as an inner face 12.

According to an embodiment, the vessel 10 is obtained by stamping a substrate 13 having at least one aluminum face designed to form the outer face 11 of the vessel 10.

According to an embodiment, the substrate 13 has two aluminum faces designed to form, respectively, the outer face 11 and the inner face 12 of the vessel 10.

If desired, the substrate 13 can be made of solid aluminum. Specifically, an alloy of aluminum 3003 can be used to this end. The substrate 13 used to produce the vessel 10 is then cut from an aluminum sheet.

According to another embodiment, the substrate 13 is formed by a colaminate having an aluminum face and a stainless steel face, the aluminum face being designed to form the outer face 11 of the vessel, the stainless steel face being designed to form the inner face 12 of the vessel 10.

According to another embodiment, the vessel 10 is made of die-cast aluminum, for example with an AlSi12 aluminum alloy.

If desired, the outer face 11 of the vessel 10 is not necessarily smooth or polished, but specifically can have a brushed or micro-blasted surface.

If desired, the vessel 10 can comprise at least one insert made of ferromagnetic material, such as a ferritic steel, for producing a cooking container 1 that can be heated by induction. Preference is given to the ferromagnetic material being a ferritic stainless steel. If desired, the insert made of ferromagnetic material can be formed by a plate having one or more perforations The insert is advantageously assembled by hot or cold stamping with the aluminum of the substrate 13 or is coated with cast aluminum, with preference given to the perforation or perforations being filled with the aluminum. The insert made of ferromagnetic material can have at least one visible part, which must be protected by masking in the acid chemical baths, specifically the anodization bath or baths.

The cooking container 1 of the invention is obtained by a method comprising the following steps:

producing a vessel 10 having an aluminum outer face 11 and an inner face 12,

carrying out hard anodization of at least the outer face 11 of the vessel 10 in order to obtain an anodic coating with pores,

wherein at least one coloring step is carried out on the anodized outer face after the hard anodization, the coloring step or at least one of the coloring steps employing at least one metal salt deposited at the bottom of the pores of the anodic coating by electrochemical means.

The implemented method can specifically comprise a degreasing step, at least one stripping step, a brightening step, and a step of anodization in a sulfuric acid solution, each of these steps being followed by rinsing.

Prior to coloring, the surfaces to be colored are subjected to scouring in an alkaline product followed by rinses and neutralization in acid medium. If desired, a preliminary mechanical preparation such as a mechanical preparation by polishing, brushing, sandblasting or grit blasting can be carried out, depending upon the surface sought. After the neutralization, a brightening can be carried out by dipping in a phosphoric acid bath.

The step of anodization in a sulfuric acid solution is carried out with an acid concentration between 10 and 500 g/l, at a temperature between −10° C. and +30° C., and with direct current having a current density between 0.1 and 5 A/dm². An anodization step carried out with direct current of 2 A/dm³ in a solution of sulfuric acid at a concentration of 180 to 190 g/l at a temperature of 10 to 15° C. for 45 to 50 min enables a deposition speed of 1 μm/min to be attained. A slightly higher temperature of ca. 5° C. enables a harder anodic coating with smaller pores to be obtained. Nevertheless the coloring is harder to achieve when the pore size is small. Preference is given to a pore size greater than 5 nm, the pore size advantageously being between 5 and 150 nm and preferably between 5 and 50 nm. The preferred treatment temperature is greater than 5° C. and less than 20° C. Tests have shown that in order to obtain a sufficiently hard anodization, the temperature of the anodization bath must be less than or equal to 17° C., and preferably less than or equal to 12° C.; in order to obtain a coloring of the anodized surface, the temperature of the anodization bath must be greater than or equal to 0° C., and preferably greater than or equal to 5° C.

The anodization operation is followed by several rinses, the last of which is carried out using distilled water. This treatment series results in the formation of an anodized layer having a thickness that varies according to the treatment time from 5 to 100 μm and a hardness ranging from 100 to 600 Vickers.

Certain colors can be obtained by depositing metal salts at the bottom of the pores of the anodic coating. As a general rule, the thicker the salt deposit, the darker the color obtained.

For other colors, it is necessary to modify the geometry of the pores prior to depositing metal salts. This modification is also effected by electrochemical means.

According to a first embodiment specifically for obtaining the colors champagne, bronze, brown, and black, the coloring step or at least one of the coloring steps employs alternating current for depositing the one or more metal salts at the bottom of the pores of the anodic coating. The metal salt employed is, for example, a salt of tin, notably a tin sulfate. The alternating current enables the metal salt to penetrate into the pores of the anodic coating; the treatment employed is an electrochemical treatment. The thickness of the metal salt deposited in the pores of the anodized layer depends upon the treatment time and determines the color obtained.

According to a second embodiment allowing a broader spectrum of colors (specifically gray, graphite, green, anthracite, burgundy, or even blue) to be obtained, a preliminary electrochemical treatment step is carried out on the anodized outer face after anodization, said preliminary treatment step employing direct current and alternating current alternately for modifying the shape of the pores of the anodic coating, the preliminary electrochemical treatment step being followed by the coloring step or at least one of the coloring steps employing alternating current for depositing the one or more metal salts at the bottom of the pores of the anodic coating.

The implemented method can notably comprise a step of modifying the pores in a solution of 40 g/l sulfuric acid at a temperature of 20° C. in which direct current, alternating current, and direct current are employed in succession.

The metal salt or at least one of the metal salts is advantageously chosen from the salts of tin, copper, nickel, cobalt, selenium, manganese, zinc, silver, gold, chromium, barium, or molybdenum.

Surprisingly, assays performed on all of the colors tested have shown that there was no alteration of the colors of the anodized outer faces thus colored.

Preference is given to the coloring step being followed by a rinse step. The rinse step can be followed by a sealing step. The sealing step can employ, for example, boiling water, or saturated steam, or a bath containing metal salts of nickel and/or lithium and/or silicon. A double sealing employing metal salts and hot water is also conceivable. In any case, having a sealing step does not appear to modify the durability of the obtained colorings significantly.

Surprisingly, assays performed on all of the colors tested have shown that there was no alteration of the colors of the anodized outer faces thus colored.

The method advantageously comprises a step of providing a PTFE coating on the inner face of the vessel. The step of providing a PTFE coating can in particular be carried out by lamination. If desired, the step of providing a PTFE coating can employ a filled PTFE for improving the resistance of the surface of the PTFE-coated inner face 12 of the vessel 10. In particular use can be made of mineral particles as a reinforcement filler. For obtaining the PTFE cooking surface, the PTFE coating is heated to a temperature above 400° C. (typically around 420° C.).

According to an embodiment, the step of anodizing the outer face 11 of the vessel 10 comes before the step of providing the PTFE coating on the inner face 12 of the vessel 10. If desired, the anodization treatment can be a hard anodization treatment. The obtaining of a PTFE coating after hard anodization is disclosed specifically in document EP 0 902 105. This arrangement makes it possible to obtain a hard base, thus improving the mechanical resistance of the PTFE coating.

According to another embodiment, the step of anodizing the outer face 11 of the vessel 10 comes after the step of providing the PTFE coating on the inner face 12 of the bowl 10. If desired, the anodization treatment can be a hard anodization treatment.

If desired, a step of carrying out a preliminary hard anodization of the outer face 11 and of the inner face 12 of the vessel 10 is conceivable prior to the step of providing a PTFE coating on the inner face 12 of the vessel 10. This prior hard anodization treatment enables a hard base under the PTFE coating to be obtained. However, a stripping of the outer face 11 of the vessel 10 is then necessary in order to re-anodize said outer face 11 before proceeding with a coloring step. The step of anodizing the outer face 11 of the vessel 10 then comes after a step of stripping the outer face 11 of the vessel 10 subsequent to the step of providing a PTFE coating on the inner face 12 of the vessel 10.

The anodization step can be carried out on the inner face 12 and the outer face 11 of the vessel 10. The anodization step is then a step in which both faces are anodized. If desired, the anodization treatment can be a treatment in which both faces are hard-anodized in order to obtain a hard base.

If desired, the coloring step can be carried out on the inner face 12 and the outer face 11 of the vessel 10 after the hard anodization step. A step of providing a PTFE coating on the inner face 12 of the vessel 10 is then conceivable after the coloring step.

Alternatively, a step of providing a PTFE coating on the inner face 12 of the vessel 10 is conceivable after the step in which both faces are anodized. Another anodization step is then carried out on the outer face 11 of the vessel 10 after the step of providing a PTFE coating on the inner face 12 of the vessel 10. The coloring step on the anodized outer face 11 of the vessel 10 comes after the other anodization step.

If desired, a surface preparation prior to the anodization can comprise acid or alkaline degreasing and/or acid or alkaline stripping and/or nitric acid (HNO₃) neutralization. A degreasing of a few minutes in a bath of NaOH at a concentration of 50 g/l at a temperature of around 50° C. gives satisfactory results.

The anodization treatment can specifically be carried out by soaking in a bath. The preliminary anodization treatment can also be carried out by soaking in a bath. The hard anodization has the advantage of effectively resisting scratches and blows. Compared to enameling, a broader range of materials is thus conceivable for producing the vessel 10 without sacrificing the cleaning properties conferred by the PTFE coating of the inner face 12 of said vessel 10.

An anodized layer having a thickness of between 10 μm and 100 μm gives satisfactory results in terms of coloring possibilities.

For obtaining a hard-anodized layer having sufficient mechanical resistance, preference is given to the anodized layer having a thickness of at least 25 μm. The hardness of the anodized layer thus obtained is greater than 350 Hv.

According to a preferred feature, the anodized outer face 11 comprises pores less than 30 nm and preferably less than 20 nm in size.

The method of the invention can comprise the following exemplary embodiments in particular:

### EXAMPLE 1

PTFE lamination of the inner face 12, anodization of the outer face 11, coloring of the hard-anodized outer face 11.

### EXAMPLE 2

PTFE lamination of the inner face 12, hard anodization of the outer face 11, coloring of the hard-anodized outer face 11.

### EXAMPLE 3

preliminary hard anodization of both faces of the vessel 10 to obtain a hard base, PTFE lamination of the inner face 12, anodization of the outer face 11, coloring of the hard-anodized outer face 11.

### EXAMPLE 4

preliminary hard anodization of both faces of the vessel 10 to obtain a hard base, PTFE lamination of the inner face 12, hard anodization of the outer face 11, coloring of the hard-anodized outer face 11.

### EXAMPLE 5

hard anodization of both faces of the vessel 10 to obtain a hard base, coloring of the hard-anodized outer face 11 and of the hard-anodized inner face 12, PTFE lamination of the inner face 12.

### EXAMPLE 6

hard anodization of both faces of the vessel 10 to obtain a hard base, coloring of the hard-anodized outer face 11 and of the hard-anodized inner face 12, PTFE lamination of the inner face 12, anodization of the outer face 11, coloring of the anodized outer face 11.

### EXAMPLE 7

hard anodization of both faces of the vessel 10 to obtain a hard base, coloring of the hard-anodized outer face 11 and of the hard-anodized inner face 12, PTFE lamination of the inner face 12, hard anodization of the outer face 11, coloring of the hard-anodized outer face 11.

### EXAMPLE 8

anodization of both faces of the vessel 10, coloring of the anodized outer face 11 and of the anodized inner face 12.

### EXAMPLE 9

hard anodization of both faces of the vessel 10 to obtain a hard base, coloring of the hard-anodized outer face 11 and of the hard-anodized inner face 12.

FIG. 2 illustrates a culinary article 100 comprising a cooking container 1 and a handle 2 attached to said cooking container 1 by at least one rivet 3. To this end, the rivet 3 is inserted in a hole bored in the vessel 10 of the cooking container 1. If desired, use can be made of several rivets 3 to attach the handle 2 to the cooking container 1. Preference is given to using between two and four rivets 3 to attach the handle 2 to the cooking container 1. Alternatively, the handle 2 could be attached to said cooking container 1 by welding. If desired, another handle 4 can be attached to said cooking container 1 by at least one other rivet 5 or by welding.

FIG. 3 illustrates an electric cooking appliance 200 comprising a cooking container 1 associated with heating means 250. The cooking container 1 forms a vessel arranged in a heating base 210 comprising the heating means 250. The outer face 11 of the vessel 10 rests on the heating means 250. If desired, the outer face 11 can be integrally formed with the heating means 250.

Alternatively, the inner face 12 of the vessel 10 does not have to be coated with PTFE; other kinds of coatings are conceivable if desired.

Alternatively, the inner face 12 of the vessel 10 does not have to be coated. Specifically, the inner face 12 of the vessel 10 can be polished if desired.

The present invention is in no way limited to the exemplary embodiments described herein, but encompasses numerous modifications in the scope of the claims.

1. Method for obtaining a cooking container, comprising the following steps:
producing a vessel having an aluminum outer face and an inner face,
carrying out hard anodization of at least the outer face of the vessel for obtaining an anodic coating having pores,
wherein at least one coloring step is carried out on the anodized outer face after anodization and wherein the coloring step or at least one of the coloring steps employs at least one metal salt deposited at the bottom of the pores of the anodic coating by electrochemical means.

2. Method for obtaining a cooking container as in claim 1, wherein the coloring step or at least one of the coloring steps employs alternating current for depositing the one or more metal salts at the bottom of the pores of the anodic coating.

3. Method for obtaining a cooking container as in claim 1, wherein after anodization a preliminary electrochemical treatment step is carried out on the anodized outer face, said preliminary electrochemical treatment step employing direct current and alternating current alternately for modifying the shape of the pores of the anodic coating, and wherein the preliminary electrochemical treatment step is followed by the coloring step or at least one of the coloring steps in which alternating current is employed for depositing the one or more metal salts at the bottom of the pores of the anodic coating.

4. Method for obtaining a cooking container as in claim 1, wherein the metal salt or at least one of the metal salts is chosen from the salts of tin, copper, nickel, cobalt, selenium, manganese, zinc, silver, gold, chromium, barium or molybdenum.

5. Method for obtaining a cooking container as in claim 1, further including a step of providing a PTFE coating on the inner face of the vessel and wherein the step of anodizing the outer face of the vessel comes after the step of providing a PTFE coating on the inner face of the vessel.

6. Method for obtaining a cooking container as in claim 5, further including a step of preliminary hard anodization of the outer face and the inner face of the vessel prior to the step of providing a PTFE coating on the inner face of the vessel and wherein the step of anodizing the outer face of the vessel comes after a step of stripping the outer face of the vessel subsequent to the step of providing a PTFE coating on the inner face of the vessel.

7. Method for obtaining a cooking container as in claim 1, wherein the anodization step and the coloring step are carried out on the inner face and the outer face of the vessel.

8. Method for obtaining a cooking container as in claim 7, further including a step of providing a PTFE coating on the inner face of the vessel after the coloring step.

9. Method for obtaining a cooking container as in claim 1, wherein the anodization is performed at a temperature greater than or equal to 0° C.

10. Method for obtaining a cooking container as in claim 9, wherein the anodization is performed at a temperature less than or equal to 17° C.

11. Method for obtaining a cooking container as in claim 1, wherein the anodization is performed at a temperature between 5° C. and 12° C.

12. Cooking container comprising a vessel having an aluminum outer face and an inner face, the outer face being anodized and colored, according to a method of claim 1.

13. Cooking container as in claim 12, wherein the vessel is obtained by stamping a substrate with at least one aluminum face.

14. Cooking container as in claim 13, wherein the substrate has two aluminum faces.

15. Cooking container as in claim 13 wherein the substrate is made of solid aluminum.

16. Cooking container as in claim 13, wherein the substrate is formed by a colaminate having an aluminum face and a stainless steel face.

17. Cooking container as in claim 12, wherein the vessel is made of die-cast aluminum.

18. Cooking container as in claim 12, wherein the outer face of the vessel has one of a brushed or micro-blasted surface.

19. Cooking container as in claim 12, wherein the vessel comprises at least one insert made of ferromagnetic material.

20. Culinary article comprising a cooking container and a handle attached to said cooking container by at least one rivet or by welding, characterized in that said cooking container complies with claim 12.

21. Electric cooking appliance comprising a cooking container associated with heating means, wherein said cooking container complies with claim 12.
